(19) United States
(12) Patent Application Publication
(10) Pub. No.: US 2026/0146301 A1
(43) Pub. Date: May 28, 2026

(54) LITHIUM RECYCLING METHOD FOR WASTE LITHIUM METAL BATTERY

(71) Applicant: SUNGEEL HITECH CO. LTD, Gunsan-si (KR)

(72) Inventors: Jin-Uk LEE, Gunsan-si (KR); Ahreum LEE, Gunsan-si (KR); Byoungjin KIM, Gunsan-si (KR); Hyeonwoo JEONG, Gunsan-si (KR)

(21) Appl. No.: 19/319,175

(22) Filed: Sep. 4, 2025

(30) Foreign Application Priority Data
Nov. 25, 2024 (KR) 10-2024-0169456

(51) Int. Cl. C22B 1/00; C01B 25/45; C01G 45/1235; C01G 51/42; C01G 53/504; C22B 7/00; C22B 26/12; H01M 10/54

(52) U.S. Cl. CPC C22B 1/005; C01B 25/45; C01G 45/1235; C01G 51/42; C01G 53/504; C22B 7/007; C22B 26/12; H01M 10/54; C01P 2002/50; C01P 2002/72; C01P 2006/40

(57) ABSTRACT

The present disclosure provides a lithium recycling method for a waste lithium metal battery, wherein the lithium metal in the anode is transferred to the cathode through overdischarge, thereby allowing the lithium metal to react with the cathode active material and be converted into an over-lithiated oxide, which blocks the high reactivity of the lithium metal with moisture.

### CROSS-REFERENCE TO RELATED APPLICATION

This application claims priority to Korean Patent Application No. 10-2024-0169456 filed on Nov. 25, 2024, and all the benefits accruing therefrom under 35 U.S.C. § 119, the contents of which are incorporated herein by reference in their entirety.

### BACKGROUND OF THE DISCLOSURE

### Field of the Disclosure

The present disclosure relates to a lithium recycling method for a waste lithium metal battery, wherein the lithium metal in the anode is transferred to the cathode through overdischarge in order to hydrometallurgically recycle the lithium metal in the waste lithium metal battery. Through this process, the lithium metal reacts with the cathode active material and is converted into an over-lithiated oxide, thereby blocking the high reactivity of the lithium metal with moisture.

### Description of the Related Art

Generally, lithium is used as a key raw material in the overall battery industry. Among various battery types, lithium metal batteries (LMBs) differ from conventional lithium-ion batteries (LIBs) in that, instead of using graphite as the anode material as in LIBs, LMBs use lithium metal as the anode material. In other words, by replacing graphite (theoretical capacity: 372 mAh/g), which is used as the anode in LIBs, with lithium metal (theoretical capacity: 3,860 mAh/g), the energy density of the battery can be significantly improved.

However, lithium (Li), an alkali metal, is highly reactive with moisture, and when lithium reacts with water, as in the reaction “2Li+2H₂O→2LiOH+H₂”, it releases hydrogen gas, posing a risk of explosion. For this reason, exposure of lithium to the atmosphere requires caution, as it is vulnerable to fire and may be difficult to extinguish with standard fire extinguishing agents.

Currently, in the battery recycling industry, lithium is primarily recovered through hydrometallurgical processes. However, the lithium metal contained in LMBs is not suitable for such processes due to its high reactivity, and thus it is necessary to control this reactivity for effective recycling.

Accordingly, through extensive research and persistent effort, the applicant of the present disclosure has completed the invention disclosed herein by developing a lithium recycling method for waste lithium metal batteries, wherein the lithium metal in the anode is transferred to the cathode through overdischarge. There, the lithium metal reacts with the cathode active material to form over-lithiated oxide, which suppresses the high reactivity of lithium metal with moisture, enabling safe hydrometallurgical recycling of the lithium metal from waste LMBs.

### RELATED PATENT DOCUMENT

Korean Registered Patent No. 10-1984719 (Registered on May 27, 2019)

### SUMMARY OF THE DISCLOSURE

Therefore, the purpose of the present disclosure is to provide a lithium recycling method for a waste lithium metal battery, wherein the lithium metal in the anode is transferred to the cathode through overdischarge so that the lithium metal reacts with the cathode active material and is converted into an over-lithiated oxide, thereby blocking the high reactivity of the lithium metal with moisture.

The challenges that the present disclosure is intended to solve are not limited to those mentioned above, and other challenges not mentioned will be apparent to those skilled in the art from the following description.

In order to achieve the purpose, an aspect of the present disclosure provides a lithium recycling method for a waste lithium metal battery, wherein lithium metal of an anode in the waste lithium metal battery is transferred to a cathode through overdischarge, such that the lithium metal reacts with a cathode material and is converted into an over-lithiated oxide, thereby blocking reactivity of the lithium metal with moisture.

In some exemplary embodiments, after overdischarge, the waste lithium metal battery may be further discharged through short discharge using a wire, such that an increased voltage caused by a voltage rebound phenomenon is maintained at 1.2 V or less.

In some exemplary embodiments, the waste lithium metal battery may be at least one selected from the group consisting of a waste lithium metal anode scrap, a lithium metal foil, and a waste lithium metal battery.

In some exemplary embodiments, the over-lithiated oxide may have a chemical formula of Li₁₊ₓMO₂(M is at least one selected from the group consisting of Co, Ni, Mn, Fe, and Al, and x≤1), and may be at least one selected from the group consisting of over-lithiated iron phosphate oxide (Li₂FePO₄), over-lithiated manganese oxide (Li₂Mn₂O₄), over-lithiated nickel cobalt manganese oxide (Li₂(Ni,Co,Mn)O₂), over-lithiated nickel cobalt aluminum oxide (Li₂(Ni,Co,Al)O₂), over-lithiated cobalt oxide (Li₂CoO₂), over-lithiated nickel oxide (Li₂NiO₂), and over-lithiated aluminum oxide (Li₂AlO₄).

In some exemplary embodiments, the overdischarge may comprise the steps of:
discharging to 1.5 V at a charge/discharge rate of 1.0 C-rate, then discharging to 0.0 V at a lower charge/discharge rate of 0.1 C-rate, followed by leaving to stand for 10 minutes; and
after the 10-minute standing, continuing the discharge while reducing the C-rate from 0.05 C-rate to 0.03 C-rate, and from 0.03 C-rate to 0.01 C-rate, until an equilibrium voltage of 1.2 V or less is reached.

In some exemplary embodiments, after the overdischarge, the waste lithium metal battery may be further discharged through short discharge using a wire such that a rebound voltage is maintained at 1.2 V or less,
when a cathode material separated from the waste lithium metal battery is immersed in water, reactivity of lithium inside the cathode material with moisture may be completely blocked, and
when an anode material separated from the waste lithium metal battery is immersed in water, reactivity of the anode material with moisture may be completely blocked.

In some exemplary embodiments, after the overdischarge, the waste lithium metal battery may be further discharged through short discharge using a wire such that a rebound voltage is maintained at 1.2 V or less,
an anode material separated from the waste lithium metal battery may not exhibit an exothermic reaction upon contact with moisture, and
the anode material separated from the waste lithium metal battery may be safe enough to allow an acid leaching experiment.

In some exemplary embodiments, after the overdischarge, the waste lithium metal battery may be further discharged through short discharge using a wire such that a rebound voltage is maintained at 1.2 V or less, and
in an acid leaching experiment of an anode material separated from the waste lithium metal battery, a leaching rate of lithium may be 80 to 99.99 wt %.

According to an exemplary embodiment of the present disclosure, a lithium recycling method for a waste lithium metal battery is provided, in which lithium metal of an anode is transferred to a cathode through overdischarge so that the lithium metal reacts with a cathode active material and is converted into an over-lithiated oxide, thereby blocking high reactivity of the lithium metal with moisture.

Thus, the process for blocking the reactivity of lithium with moisture has excellent safety, the subsequent leaching process achieves a high leaching rate of lithium, the method is environmentally friendly, and mass recovery of lithium is possible, resulting in economic advantages.

The effects of the present disclosure are not limited to the above effects, but are to be understood to include all effects that can be inferred from the detailed description of the present disclosure or from the composition of the elements as recited in the claims.

### BRIEF DESCRIPTION OF THE DRAWINGS

FIG. 1 is a graph showing the overdischarge performed in a lithium recycling method for a waste lithium metal battery according to an exemplary embodiment of the present disclosure.

FIG. 2 is an X-ray Diffraction (XRD) graph showing an over-lithiated oxide in a lithium recycling method for a waste lithium metal battery according to an exemplary embodiment of the present disclosure.

### DETAILED DESCRIPTION OF THE DISCLOSURE

Hereinafter, exemplary embodiments of the present disclosure will be described in detail with reference to related drawings.

The advantages and features of the present disclosure, and methods of accomplishing those advantages and features, will become apparent upon reference to the exemplary embodiments described in detail with reference to the accompanying drawings.

However, the present disclosure is not limited by the exemplary embodiments disclosed herein, but will be embodied in many and various forms. Therefore, those exemplary embodiments are provided merely to make the present disclosure complete and to give a complete picture of the scope of the present disclosure to one of ordinary skill in the art to which the present disclosure belongs, and the present disclosure shall be defined by the scope of the claims.

Further, hereinafter, in describing the present disclosure, a detailed description of a configuration determined that may unnecessarily obscure the subject matter of the present disclosure, for example, a detailed description of a known technology including the prior art may be omitted.

Hereinafter, exemplary embodiments of the present disclosure will be described in detail.

### Lithium Recycling Method for Waste Lithium Metal Battery

The present disclosure provides a lithium recycling method for a waste lithium metal battery, in which lithium metal of an anode is transferred to a cathode through overdischarge so that the lithium metal reacts with a cathode active material and is converted into an over-lithiated oxide, thereby blocking high reactivity of the lithium metal with moisture.

In the lithium recycling method for a waste lithium metal battery according to the present disclosure, lithium metal of an anode in the waste lithium metal battery is transferred to a cathode through overdischarge, such that the lithium metal reacts with a cathode material and is converted into an over-lithiated oxide, thereby blocking high reactivity of the lithium metal with moisture.

Accordingly, since the present disclosure provides a lithium recycling method for a waste lithium metal battery in which lithium metal of an anode is transferred to a cathode through overdischarge so that the lithium metal reacts with a cathode active material and is converted into an over-lithiated oxide, thereby blocking high reactivity of the lithium metal with moisture, the process for blocking the reactivity of lithium with moisture exhibits excellent safety, the subsequent leaching process achieves a high leaching rate of lithium, the method is environmentally friendly, and mass recovery of lithium is possible, resulting in economic advantages.

Generally, lithium is used as a key raw material in the overall battery industry. Among various battery types, lithium metal batteries (LMBs) differ from conventional lithium-ion batteries (LIBs) in that, instead of using graphite as the anode material as in LIBs, LMBs use lithium metal as the anode material. In other words, by replacing graphite (theoretical capacity: 372 mAh/g), which is used as the anode in LIBs, with lithium metal (theoretical capacity: 3,860 mAh/g), the energy density of the battery can be significantly improved.

However, lithium (Li), an alkali metal, is highly reactive with moisture, and when lithium reacts with water, as in the reaction “2Li+2H₂O→2LiOH+H₂”, it releases hydrogen gas, posing a risk of explosion. For this reason, exposure of lithium to the atmosphere requires caution, as it is vulnerable to fire and may be difficult to extinguish with standard fire extinguishing agents.

Currently, in the battery recycling industry, lithium is primarily recovered through hydrometallurgical processes. However, the lithium metal contained in LMBs is not suitable for such processes due to its high reactivity, and thus it is necessary to control this reactivity for effective recycling.

Accordingly, through extensive research and persistent effort, the applicant of the present disclosure has completed the invention disclosed herein by developing a lithium recycling method for waste lithium metal batteries, wherein the lithium metal in the anode is transferred to the cathode through overdischarge. There, the lithium metal reacts with the cathode active material to form over-lithiated oxide, which suppresses the high reactivity of lithium metal with moisture, enabling safe hydrometallurgical recycling of the lithium metal from waste LMBs.

The present disclosure may be a lithium recycling method for a waste lithium metal battery, wherein lithium metal of an anode in the waste lithium metal battery is transferred to a cathode through overdischarge, such that the lithium metal reacts with a cathode material and is converted into an over-lithiated oxide, thereby blocking high reactivity of the lithium metal with moisture.

That is, according to an exemplary embodiment of the present disclosure, a lithium recycling method for a waste lithium metal battery is provided, in which lithium metal of an anode is transferred to a cathode through overdischarge so that the lithium metal reacts with a cathode active material and is converted into an over-lithiated oxide, thereby blocking high reactivity of the lithium metal with moisture.

Thus, the process for blocking the reactivity of lithium with moisture has excellent safety, the subsequent leaching process achieves a high leaching rate of lithium, the method is environmentally friendly, and mass recovery of lithium is possible, resulting in economic advantages.

Here, the waste lithium metal battery may be at least one selected from the group consisting of a waste lithium metal anode scrap, a lithium metal foil, and a waste lithium metal battery.

In addition, the over-lithiated oxide may have a chemical formula of Li₁₊ₓMO₂(M is at least one selected from the group consisting of Co, Ni, Mn, Fe, and Al, and x≤1), and may be at least one selected from the group consisting of over-lithiated iron phosphate oxide (Li₂FePO₄), over-lithiated manganese oxide (Li₂M₂O₄), over-lithiated nickel cobalt manganese oxide (Li₂(Ni,Co,Mn)O₂), over-lithiated nickel cobalt aluminum oxide (Li₂(Ni,Co,Al)₀₂), over-lithiated cobalt oxide (Li₂CoO₂), over-lithiated nickel oxide (Li₂NiO₂), and over-lithiated aluminum oxide (Li₂AlO₄).

In addition, the over-lithiated oxide may have a chemical formula of Li₁₊ₓMO₂(M is at least one selected from the group consisting of Co, Ni, Mn, Fe, and Al, and x≤1), and at least one selected from the group consisting of over-lithiated iron phosphate oxide (Li₂FePO₄), over-lithiated manganese oxide (Li₂Mn₂O₄), over-lithiated nickel cobalt manganese oxide (Li₂(Ni,Co,Mn)O₂), over-lithiated nickel cobalt aluminum oxide (Li₂(Ni,Co,Al)O₂), over-lithiated cobalt oxide (Li₂CoO₂), over-lithiated nickel oxide (Li₂NiO₂), and over-lithiated aluminum oxide (Li₂AlO₄) may be a compound having no reactivity with moisture.

In addition, the over-lithiated oxide has a high charge/discharge capacity (about 250 mAh/g) compared to a general LIB cathode material (NCM611), but it has a characteristic in that it has not been commercialized as a cathode material due to problems of capacity degradation and voltage drop during charge/discharge.

In addition, the overdischarge may comprise the steps of:
discharging to 1.5 V at a charge/discharge rate of 1.0 C-rate, then discharging to 0.0 V at a lower charge/discharge rate of 0.1 C-rate, followed by leaving to stand for 10 minutes; and
after the 10-minute standing, continuing the discharge while reducing the C-rate from 0.05 C-rate to 0.03 C-rate, and from 0.03 C-rate to 0.01 C-rate, until an equilibrium voltage of 1.2 V or less is reached.

Here, the C-rate refers to a charge/discharge rate or a charge/discharge speed, and 1 C-rate may represent a rate at which the battery is charged or discharged for one hour.

At this time, the overdischarge may be performed by discharging to 1.5 V at a discharge rate of 1.0 C-rate (where the C-rate refers to a charge/discharge rate or a charge/discharge speed, and 1 C-rate represents a rate at which the battery is charged or discharged for one hour), then discharging to 0.0 V at a lower discharge rate of 0.1 C-rate, followed by leaving to stand (rest) for 10 minutes, and thereafter continuing the discharge while reducing the C-rate from 0.05 to 0.03, and from 0.03 to 0.01, so as to discharge until an equilibrium voltage of 1.2 V or less is reached.

That is, the overdischarge may comprise discharging to 1.5 V at a discharge rate of 1.0 C-rate (where the C-rate refers to a charge/discharge rate or a charge/discharge speed, and 1 C-rate represents a rate at which the battery is charged or discharged for one hour), then discharging to 0.0 V at a lower discharge rate of 0.1 C-rate, followed by leaving to stand (rest) for 10 minutes. Thereafter, the C-rate may be reduced from 0.05 to 0.03, and from 0.03 to 0.01, while continuing the discharge until an equilibrium voltage of 1.2 V or less is reached.

Here, when the discharge rate of the overdischarge is within the above range, lithium metal of the anode can be transferred to the cathode to react with a cathode material and be converted into an over-lithiated oxide, thereby blocking high reactivity of the lithium metal with moisture.

Here, the cathode material may be at least one selected from the group consisting of lithium iron phosphate oxide (LiFePO₄), lithium nickel cobalt manganese oxide (Li(Ni,Co,Mn)O₂), lithium manganese oxide (LiMn₂O₄), lithium nickel cobalt aluminum oxide (Li(Ni,Co,Al)O₂), and lithium cobalt oxide (LiCoO₂), but is not limited thereto.

In addition, the over-lithiated oxide may have a chemical formula of Li₁₊ₓMO₂(M is at least one selected from the group consisting of Co, Ni, Mn, Fe, and Al, and x≤1), and may be at least one selected from the group consisting of over-lithiated iron phosphate oxide (Li₂FePO₄), over-lithiated manganese oxide (Li₂M₂O₄), over-lithiated nickel cobalt manganese oxide (Li₂(Ni,Co,Mn)O₂), over-lithiated nickel cobalt aluminum oxide (Li₂(Ni,Co,Al)O₂), over-lithiated cobalt oxide (Li₂CoO₂), over-lithiated nickel oxide (Li₂NiO₂), and over-lithiated aluminum oxide (Li₂AlO₄).

In addition, the lithium recycling method for the waste lithium metal battery may perform a discharge after the overdischarge through short discharge using a wire such that a rebound voltage is maintained at 1.2 V or less.

Here, when the full discharge is performed to the above voltage or less after the overdischarge, high reactivity of the lithium metal with moisture can be blocked.

At this time, the voltage after the overdischarge may preferably be 0.0 to 1.2 V or less, and more preferably be 0.1 to 0.8 V or less.

In addition, after the overdischarge, the waste lithium metal battery may be further discharged through short discharge using a wire such that a rebound voltage is maintained at 1.2 V or less.

Afterwards, when a cathode material separated from the waste lithium metal battery is immersed in water, reactivity of lithium inside the cathode material with moisture may be completely blocked.

Moreover, when an anode material separated from the waste lithium metal battery is immersed in water, reactivity of the anode material with moisture may be completely blocked.

That is, when a cathode material separated from the waste lithium metal battery is immersed in water, generation of bubbles and a risk of explosion may not occur.

In addition, when an anode material separated from the waste lithium metal battery is immersed in water, generation of bubbles and a risk of explosion may not occur.

Here, lithium (Li), which is an alkali metal, has high reactivity with moisture, and when it reacts with moisture, as in “2Li+2H₂O→2LiOH+H₂”, hydrogen gas may be released, thereby posing a risk of explosion. For this reason, exposure of lithium to the atmosphere requires caution, lithium is vulnerable to fire, and it may be difficult to extinguish using general fire extinguishing agents.

At this time, when the lithium metal of the anode is transferred to the cathode through overdischarge and reacts with a cathode material to be converted into the over-lithiated oxide, the above-mentioned high reactivity of the lithium metal with moisture can be completely blocked.

In addition, after the overdischarge, the waste lithium metal battery may be further discharged through short discharge using a wire such that a rebound voltage is maintained at 1.2 V or less,
an anode material separated from the waste lithium metal battery may not exhibit an exothermic reaction upon contact with moisture, and
the anode material separated from the waste lithium metal battery may be safe enough to allow an acid leaching experiment.

Further, after the overdischarge, the waste lithium metal battery may be further discharged through short discharge using a wire such that a rebound voltage is maintained at 1.2 V or less, and
in an acid leaching experiment of an anode material separated from the waste lithium metal battery, a leaching rate of lithium may be 80 to 99.99 wt %.

Here, the leaching rate of lithium may preferably be 82 to 99.99 wt %, and more preferably be 85 to 99.95 wt %.

In the following, exemplary embodiments of the present disclosure will be described in more detail. However, the following exemplary embodiments are intended to further illustrate the present disclosure, and the scope of the present disclosure is not limited by the following exemplary embodiments. The following exemplary embodiments may be modified and altered as appropriate by those skilled in the art within the scope of the present disclosure.

### EXEMPLARY EMBODIMENT

### <Exemplary Embodiment 1> Method for Blocking Moisture Reactivity of Lithium in a Waste Lithium Metal Battery Through Overdischarge

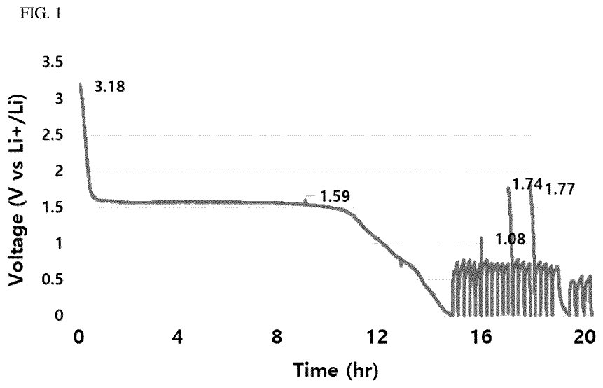

First, as shown in FIG. 1, a waste lithium metal anode scrap of an NCM-based waste lithium metal battery was transferred to a cathode through overdischarge, and reacted with a cathode material to be converted into an over-lithiated nickel cobalt manganese oxide (Li₂(Ni,Co,Mn)O₂).

FIG. 1 is a graph showing the overdischarge performed in a lithium recycling method for a waste lithium metal battery according to the exemplary embodiment 1 of the present disclosure.

Referring to FIG. 1, the overdischarge was performed by discharging to 1.5 V at a discharge rate of 1.0 C-rate, then discharging to 0.0 V at a lower discharge rate of 0.1 C-rate, followed by leaving to stand (rest) for 10 minutes. Thereafter, the discharge was continued while reducing the C-rate from 0.05 to 0.03, and from 0.03 to 0.01, until an equilibrium voltage of 1.2 V or less was reached.

After the overdischarge, the waste lithium metal battery was further discharged through short discharge using a wire such that a rebound voltage was maintained at 1.2 V or less, and then a separated cathode material of the waste lithium metal battery was immersed in water. The cathode material was completely blocked from reactivity with moisture.

Subsequently, a separated anode material of the waste lithium metal battery was immersed in water. The anode material was completely blocked from reactivity with moisture.

Thereafter, after the overdischarge, the waste lithium metal battery was further discharged through short discharge using a wire such that a rebound voltage was maintained at 1.2 V or less, and then the separated anode material of the waste lithium metal battery did not exhibit an exothermic reaction.

In addition, the separated anode material of the waste lithium metal battery was safe enough to allow an acid leaching experiment. Furthermore, the anode material was also safe enough to allow a hydrogen peroxide leaching experiment.

Thereafter, in a sulfuric acid leaching experiment of the separated anode material of the waste lithium metal battery, the leaching rate of lithium was 98 wt %.

### <Exemplary Embodiment 2> Method for Blocking Moisture Reactivity of Lithium in a Waste Lithium Metal Battery Through Overdischarge

First, as shown in FIG. 1, a waste lithium metal anode scrap of an NCA-based waste lithium metal battery was transferred to a cathode through overdischarge, and reacted with a cathode material to be converted into an over-lithiated nickel cobalt aluminum oxide (Li₂(Ni,Co,Al)O₂).

Here, the overdischarge was performed by discharging to 1.5 V at a discharge rate of 1.0 C-rate, then discharging to 0.0 V at a lower discharge rate of 0.1 C-rate, followed by leaving to stand (rest) for 10 minutes. Thereafter, the discharge was continued while reducing the C-rate from 0.05 to 0.03, and from 0.03 to 0.01, until an equilibrium voltage of 1.2 V or less was reached.

After the overdischarge, the waste lithium metal battery was further discharged through short discharge using a wire such that a rebound voltage was maintained at 1.2 V or less, and then a separated cathode material of the waste lithium metal battery was immersed in water. The cathode material was completely blocked from reactivity with moisture.

Subsequently, a separated anode material of the waste lithium metal battery was immersed in water. The anode material was completely blocked from reactivity with moisture.

Thereafter, after the overdischarge, the waste lithium metal battery was further discharged through short discharge using a wire such that a rebound voltage was maintained at 1.2 V or less, and then the separated anode material of the waste lithium metal battery did not exhibit an exothermic reaction.

In addition, the separated anode material of the waste lithium metal battery was safe enough to allow an acid leaching experiment. Furthermore, the anode material was also safe enough to allow a hydrogen peroxide leaching experiment.

Thereafter, in a sulfuric acid leaching experiment of the separated anode material of the waste lithium metal battery, the leaching rate of lithium was 96.7 wt %.

### <Exemplary Embodiment 3> Method for Blocking Moisture Reactivity of Lithium in a Waste Lithium Metal Battery Through Overdischarge

First, as shown in FIG. 1, a waste lithium metal anode scrap of an LFP-based waste lithium metal battery was transferred to a cathode through overdischarge, and reacted with a cathode material to be converted into an over-lithiated iron phosphate oxide (Li₂FePO₄).

Here, the overdischarge was performed by discharging to 1.5 V at a discharge rate of 1.0 C-rate, then discharging to 0.0 V at a lower discharge rate of 0.1 C-rate, followed by leaving to stand (rest) for 10 minutes. Thereafter, the discharge was continued while reducing the C-rate from 0.05 to 0.03, and from 0.03 to 0.01, until an equilibrium voltage of 1.2 V or less was reached.

After the overdischarge, the waste lithium metal battery was further discharged through short discharge using a wire such that a rebound voltage was maintained at 1.2 V or less, and then a separated cathode material of the waste lithium metal battery was immersed in water. The cathode material was completely blocked from reactivity with moisture.

Subsequently, a separated anode material of the waste lithium metal battery was immersed in water. The anode material was completely blocked from reactivity with moisture.

Thereafter, after the overdischarge, the waste lithium metal battery was further discharged through short discharge using a wire such that a rebound voltage was maintained at 1.2 V or less, and then the separated anode material of the waste lithium metal battery did not exhibit an exothermic reaction.

In addition, the separated anode material of the waste lithium metal battery was safe enough to allow an acid leaching experiment. Furthermore, the anode material was also safe enough to allow a hydrogen peroxide leaching experiment.

Thereafter, in a sulfuric acid leaching experiment of the separated anode material of the waste lithium metal battery, the leaching rate of lithium was 97.9 wt %.

### <Exemplary Embodiment 4> Method for Blocking Moisture Reactivity of Lithium in a Waste Lithium Metal Battery Through Overdischarge

First, as shown in FIG. 1, a waste lithium metal anode scrap of an LMO-based waste lithium metal battery was transferred to a cathode through overdischarge, and reacted with a cathode material to be converted into an over-lithiated manganese oxide (Li₂Mn₂O₄).

Here, the overdischarge was performed by discharging to 1.5 V at a discharge rate of 1.0 C-rate, then discharging to 0.0 V at a lower discharge rate of 0.1 C-rate, followed by leaving to stand (rest) for 10 minutes. Thereafter, the discharge was continued while reducing the C-rate from 0.05 to 0.03, and from 0.03 to 0.01, until an equilibrium voltage of 1.2 V or less was reached.

After the overdischarge, the waste lithium metal battery was further discharged through short discharge using a wire such that a rebound voltage was maintained at 1.2 V or less, and then a separated cathode material of the waste lithium metal battery was immersed in water. The cathode material was completely blocked from reactivity with moisture.

Subsequently, a separated anode material of the waste lithium metal battery was immersed in water. The anode material was completely blocked from reactivity with moisture.

Thereafter, after the overdischarge, the waste lithium metal battery was further discharged through short discharge using a wire such that a rebound voltage was maintained at 1.2 V or less, and then the separated anode material of the waste lithium metal battery did not exhibit an exothermic reaction.

In addition, the separated anode material of the waste lithium metal battery was safe enough to allow an acid leaching experiment. Furthermore, the anode material was also safe enough to allow a hydrogen peroxide leaching experiment.

Thereafter, in a sulfuric acid leaching experiment of the separated anode material of the waste lithium metal battery, the leaching rate of lithium was 94.6 wt %.

### <Exemplary Embodiment 5> Method for Blocking Moisture Reactivity of Lithium in a Waste Lithium Metal Battery Through Overdischarge

First, as shown in FIG. 1, a waste lithium metal anode scrap of an LCO-based waste lithium metal battery was transferred to a cathode through overdischarge, and reacted with a cathode material to be converted into an over-lithiated cobalt oxide (Li₂CoO₂).

Here, the overdischarge was performed by discharging to 1.5 V at a discharge rate of 1.0 C-rate, then discharging to 0.0 V at a lower discharge rate of 0.1 C-rate, followed by leaving to stand (rest) for 10 minutes. Thereafter, the discharge was continued while reducing the C-rate from 0.05 to 0.03, and from 0.03 to 0.01, until an equilibrium voltage of 1.2 V or less was reached.

After the overdischarge, the waste lithium metal battery was further discharged through short discharge using a wire such that a rebound voltage was maintained at 1.2 V or less, and then a separated cathode material of the waste lithium metal battery was immersed in water. The cathode material was completely blocked from reactivity with moisture.

Subsequently, a separated anode material of the waste lithium metal battery was immersed in water. The anode material was completely blocked from reactivity with moisture.

Thereafter, after the overdischarge, the waste lithium metal battery was further discharged through short discharge using a wire such that a rebound voltage was maintained at 1.2 V or less, and then the separated anode material of the waste lithium metal battery did not exhibit an exothermic reaction.

In addition, the separated anode material of the waste lithium metal battery was safe enough to allow an acid leaching experiment. Furthermore, the anode material was also safe enough to allow a hydrogen peroxide leaching experiment.

Thereafter, in a sulfuric acid leaching experiment of the separated anode material of the waste lithium metal battery, the leaching rate of lithium was 99.9 wt %.

### <Comparative Example 1> Test of Moisture Reactivity of Lithium in a Waste Lithium Metal Battery

First, a lithium ductility reaction (a property in which lithium metal deforms without breaking) of a waste lithium metal anode scrap of an NCM-based waste lithium metal battery was examined to check whether lithium metal remained.

As a result, the lithium ductility reaction was observed, and it was confirmed that lithium metal remained in the waste lithium metal anode scrap of the NCM-based waste lithium metal battery.

Then, the waste lithium metal anode scrap of the NCM-based waste lithium metal battery was immersed in water to examine moisture reactivity of the anode scrap, in order to further confirm whether lithium metal remained.

As a result, the anode scrap reacted violently or explosively with water, and was thus found to have reactivity with moisture, confirming that lithium metal remained in the waste lithium metal anode scrap of the NCM-based waste lithium metal battery.

Accordingly, a sulfuric acid leaching reaction could not be performed.

### <Comparative Example 2> Test of Moisture Reactivity of Lithium in a Waste Lithium Metal Battery

First, as shown in FIG. 1, a waste lithium metal anode scrap of an NCM-based waste lithium metal battery was transferred to a cathode through overdischarge, and reacted with a cathode material to be converted into an over-lithiated nickel cobalt manganese oxide (Li₂(Ni,Co,Mn)O₂).

Here, the overdischarge was performed by discharging to 1.5 V at a discharge rate of 1.0 C-rate, then discharging to 0.0 V at a lower discharge rate of 0.1 C-rate, followed by leaving to stand (rest) for 10 minutes. Thereafter, the discharge was continued while reducing the C-rate from 0.05 to 0.03, and from 0.03 to 0.01, until an equilibrium voltage of 1.2 V or less was reached.

After the overdischarge, however, no short discharge using a wire was performed to maintain the rebound voltage at 1.2 V or less, and thus the rebound voltage rose to 1.8 V.

Then, the separated anode material of the waste lithium metal battery was immersed in water to examine moisture reactivity of the NCM-based waste lithium metal anode scrap, in order to confirm whether lithium metal remained.

As a result, the anode scrap reacted violently or explosively with water, and was thus found to have reactivity with moisture, confirming that lithium metal remained in the NCM-based waste lithium metal anode scrap.

Accordingly, a sulfuric acid leaching reaction could not be performed.

### <Comparative Example 3> Test of Moisture Reactivity of Lithium in a Waste Lithium Metal Battery

First, as shown in FIG. 1, a waste lithium metal anode scrap of an NCM-based waste lithium metal battery was transferred to a cathode through overdischarge, and reacted with a cathode material to be converted into an over-lithiated nickel cobalt manganese oxide (Li₂(Ni,Co,Mn)O₂).

Here, the overdischarge was performed by discharging to 1.5 V at a discharge rate of 1.0 C-rate, then discharging to 0.0 V at a lower discharge rate of 0.1 C-rate, followed by leaving to stand (rest) for 10 minutes. Thereafter, the discharge was continued while reducing the C-rate from 0.05 to 0.03, and from 0.03 to 0.01, until an equilibrium voltage of 1.2 V or less was reached.

After the overdischarge, however, the waste lithium metal battery was subjected to short discharge using a wire and then left such that the rebound voltage rose to 2.0 V. The separated anode material of the waste lithium metal battery was then immersed in water to examine moisture reactivity of the NCM-based waste lithium metal anode scrap, in order to confirm whether lithium metal remained.

As a result, the anode scrap reacted violently or explosively with water, and was thus found to have reactivity with moisture, confirming that lithium metal remained in the NCM-based waste lithium metal anode scrap.

Accordingly, a sulfuric acid leaching reaction could not be performed.

TABLE 1

| | Exem- | Exem- | Exem- | Exem- | Exem- | Compar- | Compar- | Compar- |
|---|---|---|---|---|---|---|---|---|
| | plary | plary | plary | plary | plary | ative | ative | ative |
| | Embodi- | Embodi- | Embodi- | Embodi- | Embodi- | Exam- | Exam- | Exam- |
| | ment 1 | ment 2 | ment 3 | ment 4 | ment 5 | ple 1 | ple 2 | ple 3 |
| Raw | Waste | Waste | Waste | Waste | Waste | Waste | Waste | Waste |
| Material | lithium | lithium | lithium | lithium | lithium | lithium | lithium | lithium |
| | metal | metal | metal | metal | metal | metal | metal | metal |
| | anode | anode | anode | anode | anode | anode | anode | anode |
| | scrap | scrap | scrap | scrap | scrap | scrap | scrap | scrap |
| Cathode | NCM | NCA | LFP | LMO | LCO | NCM | NCM | NCM |
| Material | | | | | | | | |
| Over- | 0.1 | 0.1 | 0.1 | 0.1 | 0.1 | — | 0.1 | 0.1 |
| discharge | C~0.01 | C~0.01 | C~0.01 | C~0.01 | C~0.01 | | C~0.01 | C~0.01 |
| | C | C | C | C | C | | C | C |
| Over- | Li₂NCM | Li₂NCA | Li₂LFP | Li₂LMO | Li₂LCO | — | Li₂NCM | Li₂NCM |
| lithiated | | | | | | | | |
| Oxide | | | | | | | | |
| Number of | 3 | 8 | 4 | 2 | 10 | 0 | 0 | 0 |
| Complete | | | | | | | | |
| Discharges | | | | | | | | |
| Spark | None | None | None | None | None | Present | Present | Present |
| Reaction | | | | | | | | |
| in Water | | | | | | | | |
| Possibility | Possible | Possible | Possible | Possible | Possible | Not | Not | Not |
| of | | | | | | Possible | Possible | Possible |
| Leaching | | | | | | | | |
| Reaction | | | | | | | | |
| Lithium | 98.0 | 96.7 | 97.9 | 94.6 | 99.9 | — | — | — |
| Leaching | | | | | | | | |
| Amount | | | | | | | | |
| upon | | | | | | | | |
| Sulfuric | | | | | | | | |
| Acid | | | | | | | | |
| Leaching | | | | | | | | |
| after | | | | | | | | |
| Over- | | | | | | | | |
| discharge | | | | | | | | |
| and | | | | | | | | |
| Complete | | | | | | | | |
| Discharge | | | | | | | | |
| (wt %) | | | | | | | | |

Overdischarge: Discharging to 1.5 V at a charge/discharge rate of 1.0 C-rate, then discharging to 0.0 V at a lower charge/discharge rate of 0.1 C-rate, followed by leaving to stand (rest) for 10 minutes. Thereafter, the discharge is continued while reducing the charge/discharge rate (C-rate) from 0.05 to 0.03, and from 0.03 to 0.01, until an equilibrium voltage of 1.2 V or less is reached.
Complete Discharge: After overdischarge, short discharge using a wire is performed such that the rebound voltage is maintained at 1.2 V or less.
NCM: Lithium nickel cobalt manganese oxide (Li(Ni,Co,Mn)O₂)
NCA: Lithium nickel cobalt aluminum oxide (Li(Ni,Co,Al)O₂)
LFP: Lithium iron phosphate oxide (LiFePO₄)
LMO: Lithium manganese oxide (LiMn₂O₄)
LCO: Lithium cobalt oxide (LiCoO₂)

Referring to Exemplary Embodiments 1 to 5 and Comparative Examples 1 to 3, when the overdischarged and completely discharged waste lithium metal anode scraps of Exemplary Embodiments 1 to 5 were immersed in water, moisture reactivity was blocked.

In addition, the overdischarged and completely discharged waste lithium metal anode scraps of Exemplary Embodiments 1 to 5 could safely undergo a sulfuric acid leaching reaction.

Furthermore, the overdischarged and completely discharged waste lithium metal anode scraps of Exemplary Embodiments 1 to 5 could safely undergo a hydrogen peroxide leaching reaction.

Accordingly, the overdischarged and completely discharged waste lithium metal anode scraps of Exemplary Embodiments 1 to 5 could be safely recycled through a hydrometallurgical process. That is, lithium metal in the waste lithium metal batteries could be safely recycled by a wet process.

However, since the waste lithium metal anode scraps of Comparative Examples 1 to 3 reacted violently with moisture, they could not be safely recycled by a wet process.

### <Experimental Example> XRD Measurement of Over-Lithiated Oxides According to Overdischarge in the Lithium Recycling Method for a Waste Lithium Metal Battery

The over-lithiated oxide formed by overdischarge in the lithium moisture reactivity blocking method of the waste lithium metal anode scrap of the exemplary embodiment 1 was analyzed and confirmed using X-ray diffraction (XRD).

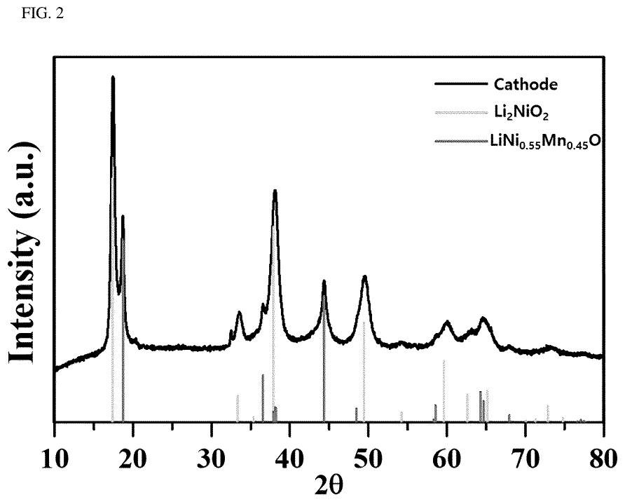

FIG. 2 is an XRD graph showing an over-lithiated oxide in a lithium recycling method for a waste lithium metal battery according to the exemplary embodiment 1 of the present disclosure.

Referring to FIG. 2, the over-lithiated oxide peak (Li₂NiO₂) formed by the overdischarge of the NCM-based waste lithium metal anode scrap in Exemplary Embodiment 1, and the conventional NCM peak (LiNi_{0.55}Mn_{0.45}O₂), were measured.

In addition, the cathode peak in FIG. 2 includes both the over-lithiated oxide peak (Li₂NiO₂) and the conventional NCM peak (LiNi_{0.55}Mn_{0.45}O₂).

In the above, exemplary embodiments of the lithium recycling method for a waste lithium metal battery according to the present disclosure have been described. Moreover, it will be appreciated that various modifications to these exemplary embodiments are possible without departing from the scope of the present disclosure.

The scope of the present disclosure should therefore not be limited to those exemplary embodiments described above, but should be defined by the following claims and their equivalents.

In other words, the foregoing exemplary embodiments are to be understood as illustrative rather than restrictive in all respects, and the scope of the present disclosure is indicated by the following claims rather than the detailed description. All modifications or variations derived from the meaning, scope, and equivalent concepts of the claims should be interpreted as being included within the scope of the present disclosure.

What is claimed is:

1. A lithium recycling method for a waste lithium metal battery,
wherein lithium metal of an anode in the waste lithium metal battery is transferred to a cathode through overdischarge, such that the lithium metal reacts with a cathode material and is converted into an over-lithiated oxide, thereby blocking reactivity of the lithium metal with moisture.

2. The lithium recycling method of claim 1,
wherein, after overdischarge, the waste lithium metal battery is further discharged through short discharge using a wire, such that an increased voltage caused by a voltage rebound phenomenon is maintained at 1.2 V or less.

3. The lithium recycling method of claim 1,
wherein the waste lithium metal battery is at least one selected from the group consisting of a waste lithium metal anode scrap, a lithium metal foil, and a waste lithium metal battery.

4. The lithium recycling method of claim 1,
wherein the over-lithiated oxide has a chemical formula of Li₁₊ₓMO₂(M is at least one selected from the group consisting of Co, Ni, Mn, Fe, and Al, and x≤1), and is at least one selected from the group consisting of over-lithiated iron phosphate oxide (Li₂FePO₄), over-lithiated manganese oxide (Li₂Mn₂O₄), over-lithiated nickel cobalt manganese oxide (Li₂(Ni,Co,Mn)O₂), over-lithiated nickel cobalt aluminum oxide (Li₂(Ni,Co,Al)O₂), over-lithiated cobalt oxide (Li₂CoO₂), over-lithiated nickel oxide (Li₂NiO₂), and over-lithiated aluminum oxide (Li₂AlO₄).

5. The lithium recycling method of claim 1,
wherein the overdischarge comprises:
discharging to 1.5 V at a charge/discharge rate of 1.0 C-rate, then discharging to 0.0 V at a lower charge/discharge rate of 0.1 C-rate, followed by leaving to stand for 10 minutes; and
after the 10-minute standing, continuing the discharge while reducing the C-rate from 0.05 C-rate to 0.03 C-rate, and from 0.03 C-rate to 0.01 C-rate, until an equilibrium voltage of 1.2 V or less is reached.

6. The lithium recycling method of claim 1,
wherein, after the overdischarge, the waste lithium metal battery is further discharged through short discharge using a wire such that a rebound voltage is maintained at 1.2 V or less,
wherein, when a cathode material separated from the waste lithium metal battery is immersed in water, reactivity of lithium inside the cathode material with moisture is completely blocked, and
wherein, when an anode material separated from the waste lithium metal battery is immersed in water, reactivity of the anode material with moisture is completely blocked.

7. The lithium recycling method of claim 1,
wherein, after the overdischarge, the waste lithium metal battery is further discharged through short discharge using a wire such that a rebound voltage is maintained at 1.2 V or less,
wherein an anode material separated from the waste lithium metal battery does not exhibit an exothermic reaction upon contact with moisture, and
wherein the anode material separated from the waste lithium metal battery is safe enough to allow an acid leaching experiment.

8. The lithium recycling method of claim 1,
wherein, after the overdischarge, the waste lithium metal battery is further discharged through short discharge using a wire such that a rebound voltage is maintained at 1.2 V or less, and
wherein, in an acid leaching experiment of an anode material separated from the waste lithium metal battery, a leaching rate of lithium is 80 to 99.99 wt %.
